(19) United States
(12) Patent Application Publication
(10) Pub. No.: US 2015/0137574 A1
(43) Pub. Date: May 21, 2015

(54) WORK-ASSIST DEVICES

(71) Applicant: Steven D. Meyer, Rochester, MN (US)

(72) Inventor: Steven D. Meyer, Rochester, MN (US)

(21) Appl. No.: 14/546,307

(22) Filed: Nov. 18, 2014

Related U.S. Application Data
(60) Provisional application No. 61/931,348, filed on Jan. 24, 2014.
(60) Provisional application No. 61/906,564, filed on Nov. 20, 2013.

(51) Int. Cl. B25H 5/00; E21B 7/02; A01C 5/04; A47C 16/04; E02F 3/02

(52) U.S. Cl. CPC B25H 5/00; A47C 16/04; E02F 3/02; A01C 5/04; E21B 7/027
USPC 297/423.11; 280/32.5; 414/685; 175/219

(57) ABSTRACT

A work-assist device includes a chest-support member configured to support a user's chest when the user is using the work-assist device. The work-assist device also includes a knee-support member configured to support the user's knees when the user is using the work-assist device. The knee-support member includes a pad having a curved lower surface and configured to cause the work-assist device to rock forward or backward in response to a weight shift by the user when the user is using the work-assist device. The work-assist device further includes an elongate frame member that includes a first end and a second end, where the first end is attached to the knee support member and the second end is attached to the chest support member. The work-assist device is configured to fully support the user in a forward-biased position when the user is using the work-assist device.

### CROSS-REFERENCE TO RELATED APPLICATIONS

This application claims the benefit of U.S. Provisional Application No. 61/931,348, filed Jan. 24, 2014, entitled “WORK-ASSIST DEVICES,” and also claims the benefit of U.S. Provisional Application No. 61/906,564, filed Nov. 20, 2013, entitled “WORK-ASSIST DEVICES,” and the entire contents of each of these applications are hereby incorporated by reference.

### TECHNICAL FIELD

This document describes devices that can support a user and aid the user in performing work.

### BACKGROUND

Gardening is an activity that has traditionally involved working for extended periods of time in uncomfortable positions, or in positions that are not conducive to effectively performing gardening tasks. For example, a gardener may work from a generally standing position while bending at the waist to reach down and work near the ground. A gardener may alternatively crouch, and lean forward and down with their upper body. As further examples, the gardener may kneel, with one or both knees on the ground, and lean forward, or may sit on the ground with legs spread and lean forward, or may sit on the ground with legs together or crossed and turn to the side to work. Some of these positions may cause undue stress on one or more of the gardener's back, knees, ankles, or other areas of the body. In some cases, the stress can lead to discomfort, pain or injury. Depending on the gardener's general level of mobility, getting down (e.g., lowering oneself) or getting up (e.g., raising oneself) from one of these traditional gardening positions may also be difficult or problematic.

Often, a gardener may prefer to use both hands simultaneously for performing the gardening task, as opposed to gardening with one hand while supporting themself with the other hand. For example, many gardening tasks may be difficult to perform using a single hand, but may be routinely performed using two hands.

### SUMMARY

In a first general aspect, a work-assist device includes a chest-support member configured to support a user's chest when the user is using the work-assist device. The work-assist device also includes a knee-support member configured to support the user's knees when the user is using the work-assist device. The knee-support member includes a pad having a curved lower surface and configured to cause the work-assist device to rock forward or backward in response to a weight shift by the user when the user is using the work-assist device. The work-assist device further includes an elongate frame member that includes a first end and a second end, where the first end is attached to the knee support member and the second end is attached to the chest support member. The work-assist device is configured to fully support the user in a forward-biased position when the user is using the work-assist device.

Various implementations may include one or more of the following. The knee-support member may include a second frame member, the second frame member may be attached to the first end of the elongate frame member, and the pad may include a left pad and a right pad, each having a curved lower surface. The elongate frame member may extend from the chest-support member at an angle within the range of 45-80 degrees. The angle may be about 60 degrees. The elongate frame member may include a first telescoping portion and a second telescoping portion, and a length of the elongate frame member may be adjustable. The work-assist device may also include a stability member attached to the elongate frame member, and the stability member may be configured to prevent the work-assist device from rocking forward beyond a predetermined position when the stability member is disposed in an open position.

In a second general aspect, a work-assist device includes a chest-support member configured to support a user's chest when the user is using the work-assist device. The work-assist device also includes a knee-support platform configured to support the user's knees when the user is using the work-assist device. The work-assist device further includes a frame that includes a first frame portion and a second frame portion, where the first frame portion is attached to the knee-support platform, and where the second frame portion is attached to the first frame portion and to the chest-support member. Each of the first frame portion and the second frame portion are collapsible. The work-assist device is configured to fully support the user in a forward-biased position when the user is using the work-assist device.

Various implementations may include one or more of the following. The chest-support member may include a forward- and downward-sloping curved bar.

In a third general aspect, a work-assist device includes a frame that includes a first frame tube and a second frame tube, where the first frame tube and the second frame tube each have a curved configuration and a first end and a second end. The first frame tube is attached to the second frame tube at an attachment point near a center portion of the first frame tube and a center portion of the second frame tube. The work assist device also includes first and second wheels, attached respectively to the first end of the first frame tube and the second end of the first frame tube, and third and fourth wheels, attached respectively to the first end of the second frame tube and second end of the second frame tube. The first and third wheels define a first wheelbase and the second and fourth wheels define a second wheelbase, and the first wheelbase about three times as wide as the second wheelbase. The work-assist device further includes a chest-support member configured to support a user's chest when the user is using the work-assist device, and a saddle attached to the frame and configured to support the user when the user is using the work-assist-device. The work-assist device further includes an adjustment member that is attached to the frame, and a third frame tube attached to the chest-support member and to the adjustment member. An angle of the third frame tube with respect to the saddle is adjustable by selecting a setting of the adjustment member. The work-assist device is configured to fully support the user in a forward-biased position when the user is using the work-assist device.

Various implementations may include one or more of the following. The work-assist device may further include a storage member attached to the frame, a handle component attached to the third frame tube, or first and second shoulder-receiving elements attached to the handle component. The third frame tube may includes a first telescoping portion and a second telescoping portion, and a length of the third frame tube may be adjustable. The work-assist device may further include a digger attachment, an auger attachment, or a tray attachment. The work-assist device may further include one or more springs that provide resistance when pressure is applied to the chest-support member. A width of the saddle may taper from a front portion of the saddle to a back portion of the saddle. The saddle may include a generally upward-extending rear portion, a generally downward-extending left side portion and a generally downward-extending right side portion. The angle of the third frame tube with respect to the saddle may be adjustable in a range of about 120 degrees to about 180 degrees.

### BRIEF DESCRIPTION OF THE DRAWINGS

FIG. 1 is a side view of an example work-assist device.

FIG. 2 is a perspective view of the example work-assist device of FIG. 1.

FIG. 3 is a rear view of the example work-assist device of FIG. 1.

FIG. 4 is an end view of an example knee support member.

FIG. 5 is a view of a user working using an example work-assist device.

FIGS. 6a-6f are views of a user using the example work-assist device of FIG. 1.

FIGS. 7-10 are additional views of the work-assist device of FIG. 1.

FIG. 11 is a side view of another example work-assist device.

FIG. 12 is a perspective view of the example work-assist device of FIG. 11.

FIG. 13 is a rear view of the example work-assist device of FIG. 11.

FIG. 14 is a perspective view of another example work-assist device.

FIG. 15a is a view of the example work-assist device of FIG. 11, where a first portion of the device is collapsed for storage.

FIG. 15b is a view of the example work-assist device of FIG. 11, where the first portion and a second portion of the device are collapsed for storage.

FIGS. 16a-16f are views of a user using the example work-assist device of FIG. 11.

FIG. 17 is a view of a user working using the example work-assist device of FIG. 11.

FIGS. 18-22 are additional views of the work-assist device of FIG. 11.

FIGS. 23-25 are perspective views of yet another example work assist device.

FIG. 26 is a top view of example frame components of the work assist device of FIG. 23.

FIG. 27a is a perspective view of another example work assist device.

FIG. 27b is an enlarged view of an example collapsing mechanism of the device of FIG. 27a.

FIG. 28a is a perspective view of yet another example work assist device.

FIG. 28b is a top view of example frame components of the work assist device of FIG. 28a.

FIGS. 29a-29f are views of a user using the example work-assist device of FIG. 23.

FIG. 30 is a view of a user working using the example work-assist device of FIG. 23.

FIGS. 31-38 are additional views of the work-assist device of FIG. 23.

FIG. 39 is a perspective view of an example work-assist device that includes a digger attachment.

FIG. 40 is a perspective view of an example work-assist device that includes an auger attachment.

FIG. 41 is a perspective view of an example work-assist device that includes a tray attachment.

FIG. 42 is a perspective view and FIG. 43 is a front view, respectively, of an example work assist device that includes one or more handles.

FIGS. 44a, 44b, and 44c are perspective views of a portion of the example work assist device of FIGS. 42 and 43.

FIG. 45 is a view of an example tension system of an example work assist device.

FIGS. 46a, 46b, and 46c are perspective views of a portion of the example work-assist device of FIGS. 42-45, and illustrate how an example tension system provides resistance to forward pressure against the chest support member of the device.

FIG. 47 is a view of an example brake element.

FIG. 48 is a front view of an example work-assist device.

Like reference symbols in the various drawings indicate like elements.

### DETAILED DESCRIPTION

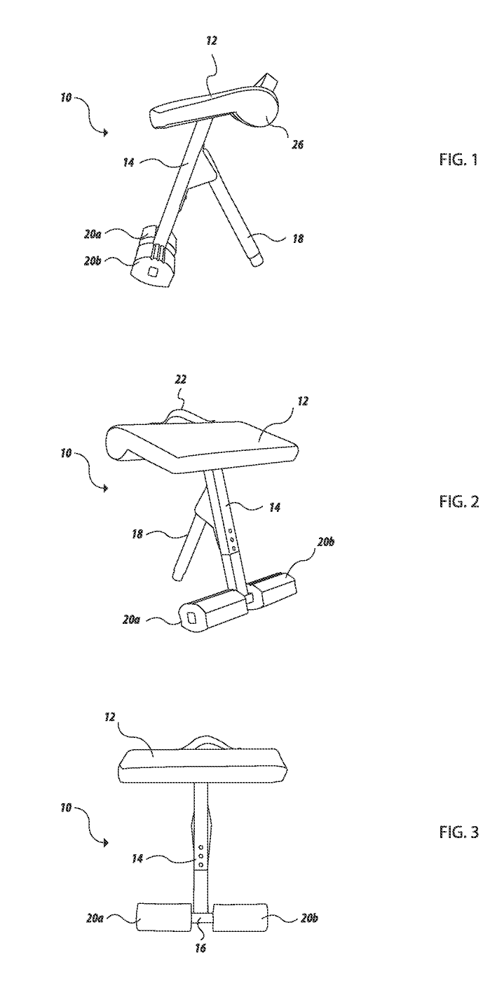

FIGS. 1, 2 and 3 are views of a first embodiment of an example work-assist device 10. FIG. 1 is a side view, FIG. 2 is a perspective view, and FIG. 3 is a rear view of the work-assist device 10. Without limitation, the work-assist device 10 can be used for gardening, ceramic tiling, floor treatment or restoration, painting, auto detailing, maintenance or repair, retail stocking, general household cleaning, or other uses. The work-assist device 10 includes a chest support member 12, a first frame member 14, a second frame member 16 (see FIG. 3), an optional stability member 18, first and second knee support members 20a and 20b, and an optional carrying handle 22.

The first frame member 14 is attached at a first end to the second frame member 16, and is attached at a second end to the chest support member 12. In some implementations, the first frame member 14 extends at an angle of about 60 degrees with respect to the second frame member 16. In some examples, the angle that first frame member extends from second frame member is in a range of about 45-80 degrees, (e.g., 45 degrees, 50 degrees, 55 degrees, 60 degrees, 65 degrees, 70 degrees, 75 degrees, or 80 degrees). In some implementations, the first frame member 14 is length-or height-adjustable, so that a desired distance between the second frame member 16 and the chest support member 12 can be selected to comfortably accommodate users of different heights.

First frame member 14 and second frame member 16 can be aluminum tubing in some examples, and can have any appropriate cross-sectional shape. In the depicted examples, first frame member 14 and second frame member 16 have a square cross-section, but in other examples one or both of the frame members may have a rectangular, circular, elliptical, triangular, or other appropriate cross-sectional shape. In other examples, one or both of the frame members 14, 16 can be formed of plastic, or of another type of metal (e.g., steel, stainless steel). In some examples, the tubing of the frame members can be 0.5″ tubing. In some examples, the tubing of the frame members can be 0.75″ tubing. In some examples, the tubing of the frame members can be 1.0″ tubing.

In some examples, first frame member 14 includes an upper telescoping portion and a lower telescoping portion, each of which can include one or more (e.g., one, two, three, four, five, six, seven, eight, or more) holes. In some examples one of the telescoping portions includes a single hole and the other telescoping portion includes two or more holes. Appropriate holes of the respective telescoping portions may be aligned, and a pin may be inserted through the holes to set the height or length of the first frame member 14. In some examples, the upper telescoping portion slides within the lower telescoping portion and in the other examples the lower telescoping portion slides within the upper telescoping portion. In some examples, the first frame member is not length adjustable.

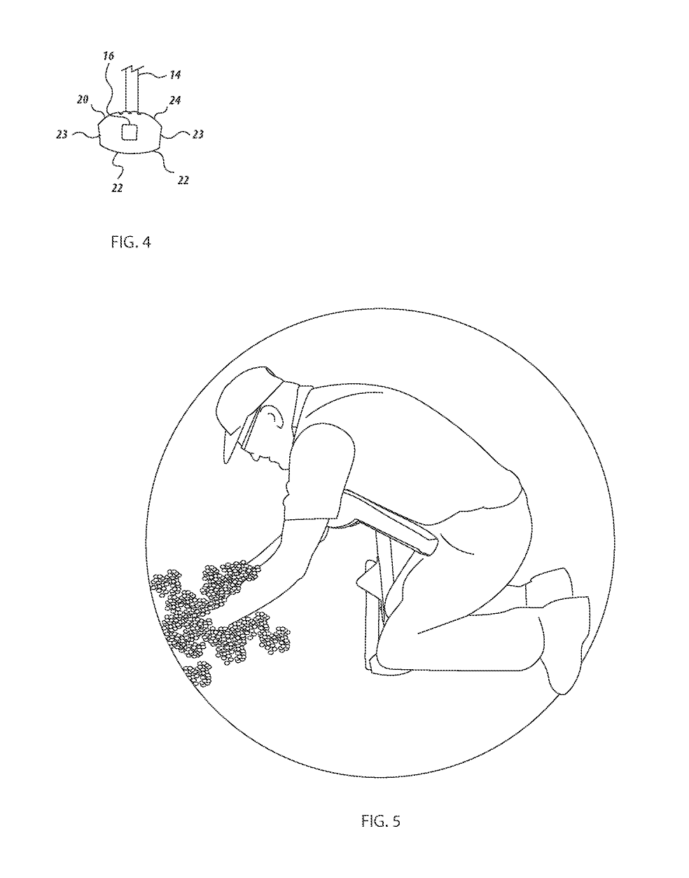

The knee support members 20a and 20b are in contact with the second frame member 16. In some examples the knee support members 20a, 20b are foam pads (e.g., high density foam). Each foam pad may surround a portion of the second frame member 16 in some implementations. For example, each of the knee support members 20a, 20b can include a hole longitudinally through the knee support member 20a or 20b, and the respective portion of the second frame member 16 can extend through the hole in the corresponding knee support member 20a or 20b. As can be seen in FIG. 4, the second frame member 16 has a square cross section to prevent the knee support member 20 from slipping with respect to the second frame member 16. In some examples, knee support members 20a, 20b include a curved or contoured lower surface designed to permit rocking of the device 10 forward or backward.

FIG. 4 is a side view of an example knee support member 20 (e.g., knee support member 20a). As can be seen in FIG. 4, a bottom surface 22 of the knee support member is curved, which permits the work-assist device to advantageously rock forward or backward based on the user shifting his or her weight. By rocking forward, for example, a user may be able to reach farther forward than they would be able to otherwise. For example, the user may lean forward against the chest support member 12, and the device may rock forward to facilitate access to a work area in front of the device 10. Similarly, the user may lean backwards and cause the device 10 to rock backwards, which may make it easier to raise oneself up from a working position when finished using the device 10. In some examples, the forward-facing and backward-facing surfaces 23 of the knee support member 20 are straight. These straight surfaces 23, and the contrast between the curved lower surface 22 and the straight surfaces 23 may indicate to a user rocking forward or rearward with the device that they have rocked as far forward or backward as permitted by the device (i.e., may act as an indicator to the user). In some examples, an upper surface 24 of the knee support member 20 includes channels or grooves for added comfort. In some examples, the upper surface of the knee support member may be contoured to receive the user's knee. In some examples, the bottom surface of the knee support members may be generally flat and may not be curved.

The stability member 18 is attached at one end to the first frame member 14. In some embodiments, the stability member 18 can pivot between a closed position and an open position. In the closed position, the stability member 18 is tucked adjacent and generally parallel to the first frame member 14 for ease of storage or transport. In the open or deployed position the stability member 18 extends at an angle from the first frame member 14 and prevents the device from falling forward. The stability member 18 may function as a “kickstand” to hold the device 10 upright, for example. FIG. 1 shows the stability member 18 in the open position. In some examples, the device may include one or more locking features that can lock the stability member 18 in the open position or in the closed position. In some examples, the stability member may be held in the closed or open position by a friction fit. Some embodiments of the work-assist device 10 do not include the stability member 18.

The chest support member 12 can include a platform that is attached to the first frame member 14, and a pad member that is attached to the platform. The chest support member 12 is configured to support a user's chest when the user is using the work-assist device 10. The chest support member 12, or the pad of the chest support member, can have various shapes. In some examples, the chest support member 12 is generally flat or planar. In some examples, the chest support member 12 has a contour. In the depicted example, the chest support member 12 includes an arm-support pad 26 as the front portion of the chest support member 12. The arm-support pad 26 is configured to support the rear portion of the upper arm of the user (e.g., the triceps area) when the user is working using the device 10. In the depicted example, the arm support pad 26 is rounded. In some examples, the arm support pad 26 may include contours for receiving the user's arms. For example, the arm support pad 26 can include areas that are contoured for anatomical contact with the user's arms. In some examples, the arm-support pad 26 is configured to support the underarm area of the user when the user is working using the device 10 without pinching. When the stability member is in the open position, the chest support member 12 may be angled at about 15-25 degrees with respect to the ground, for comfortable engagement (e.g., contact) with the users' chest as the user assumes a working position on the device. The carrying handle 22 is located on a central portion of the arm support pad 26 so that it does not interfere with the user's chest contacting the chest support member 12 or the user's arms contacting the arm support pad 26, according to some implementations. Some examples of device 10 do not include a carrying handle.

FIG. 5 is a view of a user working using the example work-assist device 10. As can be seen in FIG. 5, the user's knees are comfortably resting on the knee support members, and the user's chest is comfortably resting against the chest support member. The user's arms are comfortably draped over the front of the chest support member, and the device facilitates a comfortable working position. For example, the device provides stable and comfortable support in a forward-biased position, so that both of the user's hands are free to perform work (gardening in the depicted example) and so that the user does not need to use one or both of his hands to support himself while working. Regarding facilitating the user to work in a forward-biased position, the device may be configured to position the user to work in a position where the user would otherwise fall forward because of the forward bias if not for the support provided by the device. The device 10 can support the user in the forward-biased position, and can permit comfortable work positions that do not invoke undue stress on the user's body, for example. In the depicted example, the user is gardening, but as described above, the device can be used for many types of work.

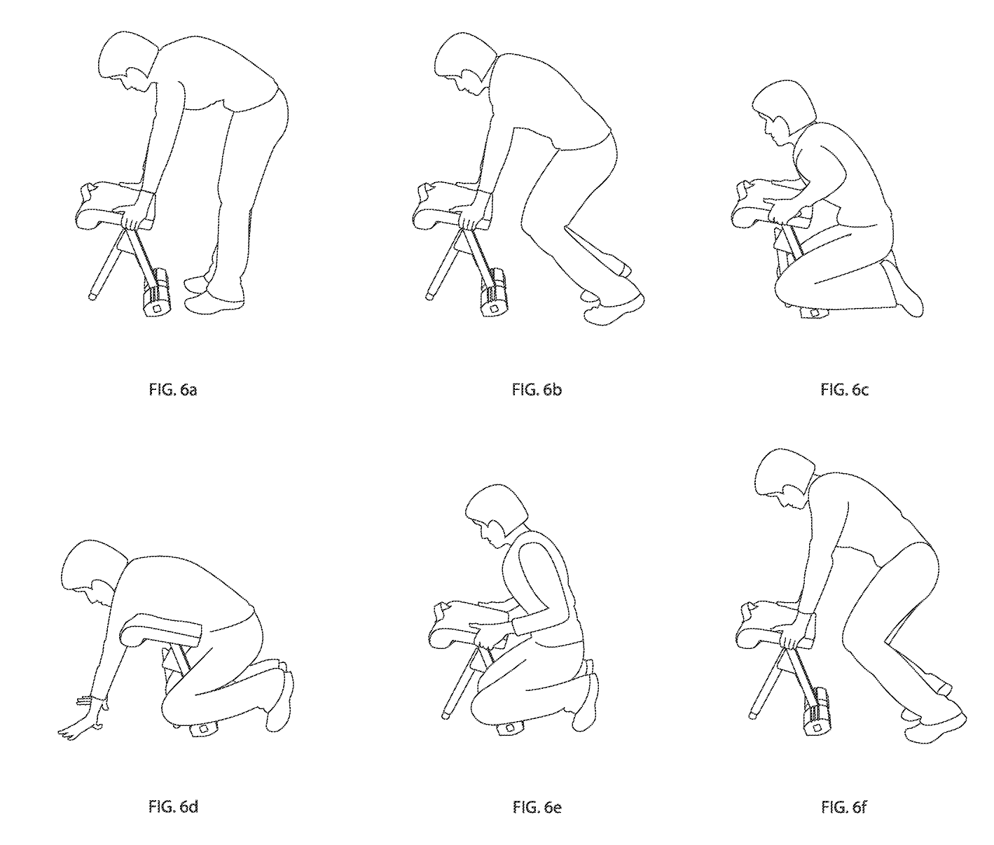

FIGS. 6a-6f are views of a user using the example work-assist device 10 of FIG. 1. FIG. 6a shows a user preparing to lower herself onto the device 10. The user is shown grabbing each side of the chest support member 12 in FIG. 6a. In FIG. 6a, the stability member 18 is in the open position, and is acting as a kickstand for the device to stabilize the device. In some examples, the chest support member 12 can include handles on the sides of the chest support member 12. FIG. 6b shows the user lowering herself onto the device 10, by crouching down. The user is using the chest support member 12 for support as she lowers herself. FIG. 6c shows that the user has placed her knees onto the knee support members 20a and 20b.

FIG. 6d shows that the user has lowered her chest onto the chest support member 12, and the user's knees remain on the knee support members 20a and 20b. As shown in FIG. 6d, the user is in a comfortable working position, with both hands free to work near the ground. In particular, the device 10 positions the user's back in a relatively straight and un-arched position, so that the user is unlikely to experience discomfort due to back strain, even during extended working sessions using the device 10. The user's weight is being fully supported by the device 10, without straining the user's knees or lower back. In this example, the stability member 18 is in the open position and prevents the device 10 from being leaned further forward. In other examples, the user may choose to use the device 10 with the stability member 18 in the closed position, for example. FIG. 6e shows the user preparing to raise herself from the device 10. As compared to the view of FIG. 6d, the user in FIG. 6e has leaned back and positioned her hands on the sides of the chest support member 12. In examples where the knee support members 20 include a curved bottom surface, the device may rock backward when the user shifts her weight backward, which may aid the user in preparing to raise herself from the device. FIG. 6f shows the user raising herself from the device.

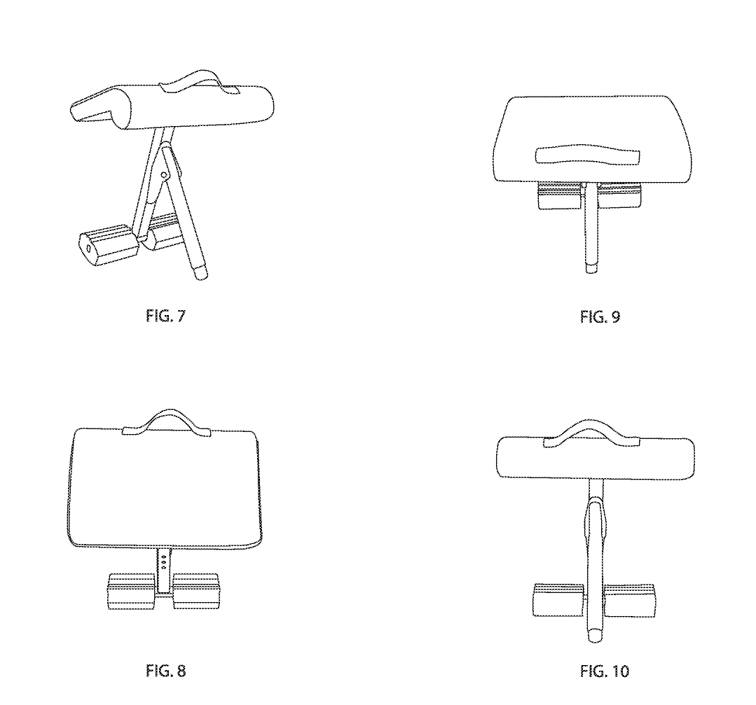

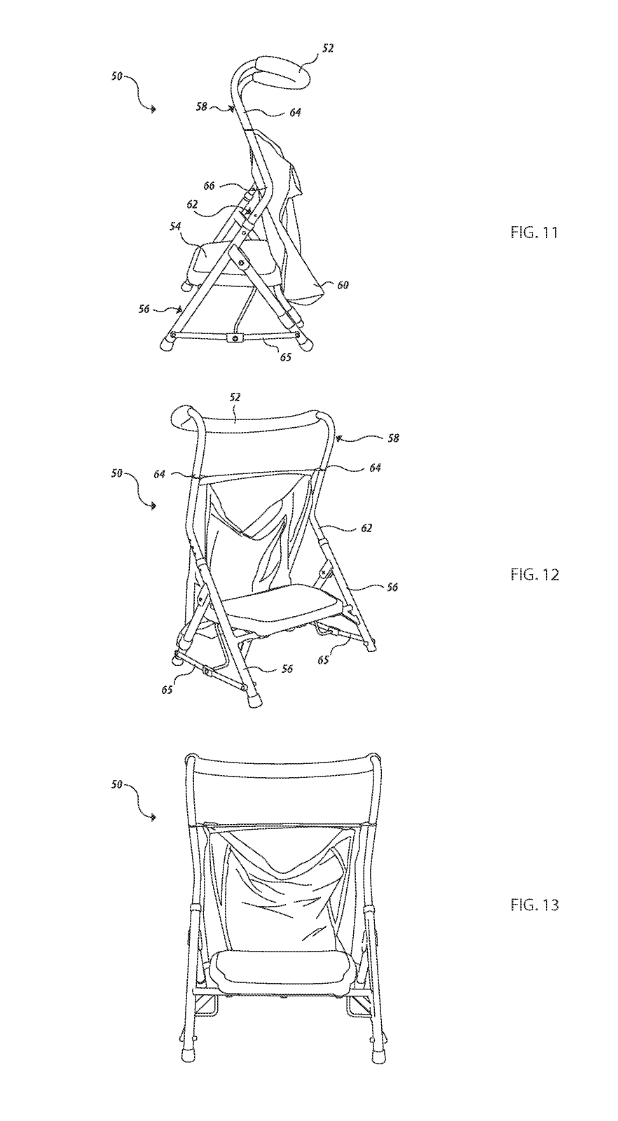

FIG. 7 is a perspective view of the example work-assist device 10. FIG. 8 is a top view of the work-assist device 10. FIG. 9 is a perspective view of the work-assist device 10. FIG. 10 is a front view of the example work-assist device 10. In some examples, the device 10 includes a storage element, such as a mesh bag, attached to the underside of the chest support member. The storage element can be used to store tools (e.g., garden tools), waste (e.g., weeds, leaves, garbage), clothing items (e.g., gloves, sunglasses, an extra shirt, a towel), or other supplies (e.g., sunscreen, insect repellant, beverages, snacks, a music-playing device, a phone, or the like). In some examples, a bar or loop for hanging tools (e.g., garden tools) can be included on the underside of the chest support member 12 or the underside of the arm support pad 26.

FIGS. 11, 12 and 13 are views of a second embodiment of an example work-assist device 50. FIG. 11 is a side view, FIG. 12 is a perspective view, and FIG. 13 is a rear view of the work-assist device 50. Without limitation, the work-assist device 50 can be used for gardening, ceramic tiling, floor treatment or restoration, painting, auto detailing, maintenance or repair, retail stocking, general household cleaning, or other uses. The work-assist device 50 includes a chest support member 52, a knee support member 54, a first frame portion 56, a second frame portion 58, and an optional storage member 60.

The knee support member 54 can include a platform that is attached to the first frame portion 56, and a pad member that is attached to the platform. The knee support member 54 is configured to support a user's knees, and in some examples a user's upper shins, when the user is using the work-assist device 50. The knee support member 54, or the pad of the knee support member, can have various shapes. In some examples, the knee support member 54 is generally flat or planar. In some examples, the knee support member 54 has a pair of depressions or channels configured to receive the user's knees and/or upper shins.

The first frame portion 56 is connected to the knee support member 54 and suspends the knee support member 54 several inches above the ground (e.g., about 2 inches, about 2.5 inches, about 3 inches, about 3.5 inches, about 4 inches, about 4.5 inches, about 5 inches, about 5.5 inches, about 6 inches), so that when a user is using the device 50 with their knees on the knee support member 54, the user's legs can extend behind the device 50, several inches off the ground, so that the users ankles and feet can comfortably dangle stress-free or substantially stress-free to the ground. This may relieve stress on the user's ankles, feet, and toes, for example. In some examples, the first frame member 56 can include a feature for adjusting the height of the knee support member.

In general, as can be seen in FIGS. 11-13, the first frame portion 56 and the second frame portion 58 each include components that are symmetrical with respect to one another on either side of the knee support member 54 and the chest support member 52. In some examples, the first frame portion 56 includes one or more (e.g., two, three, four) supports between the components of the first frame portion 56 and under the knee support member 54 to support the knee support member 54. The first frame portion 56 also includes, in some examples, components that permit the first frame member 56 to collapse for storage.

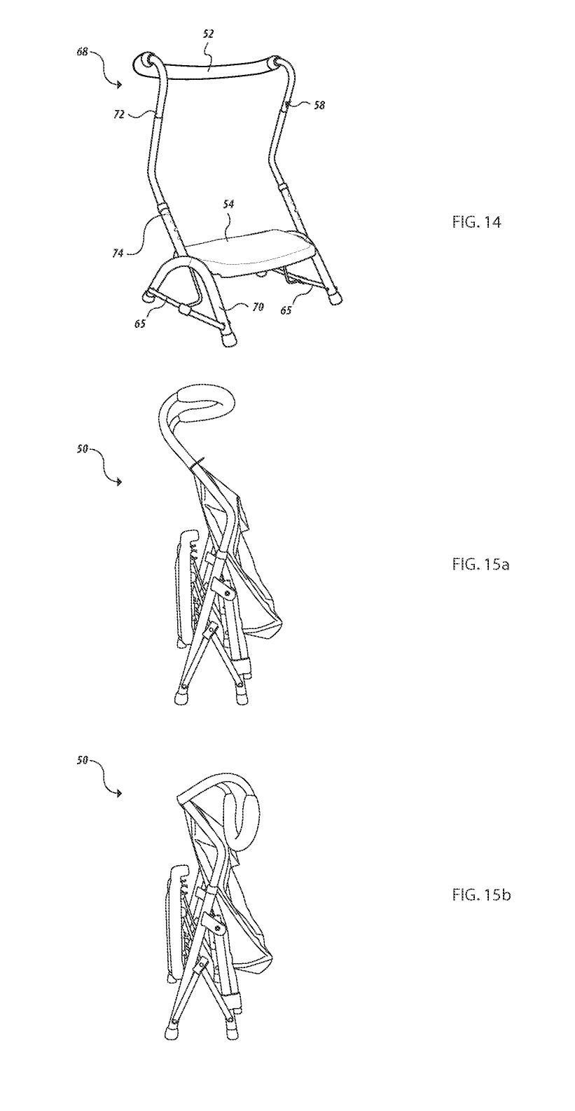

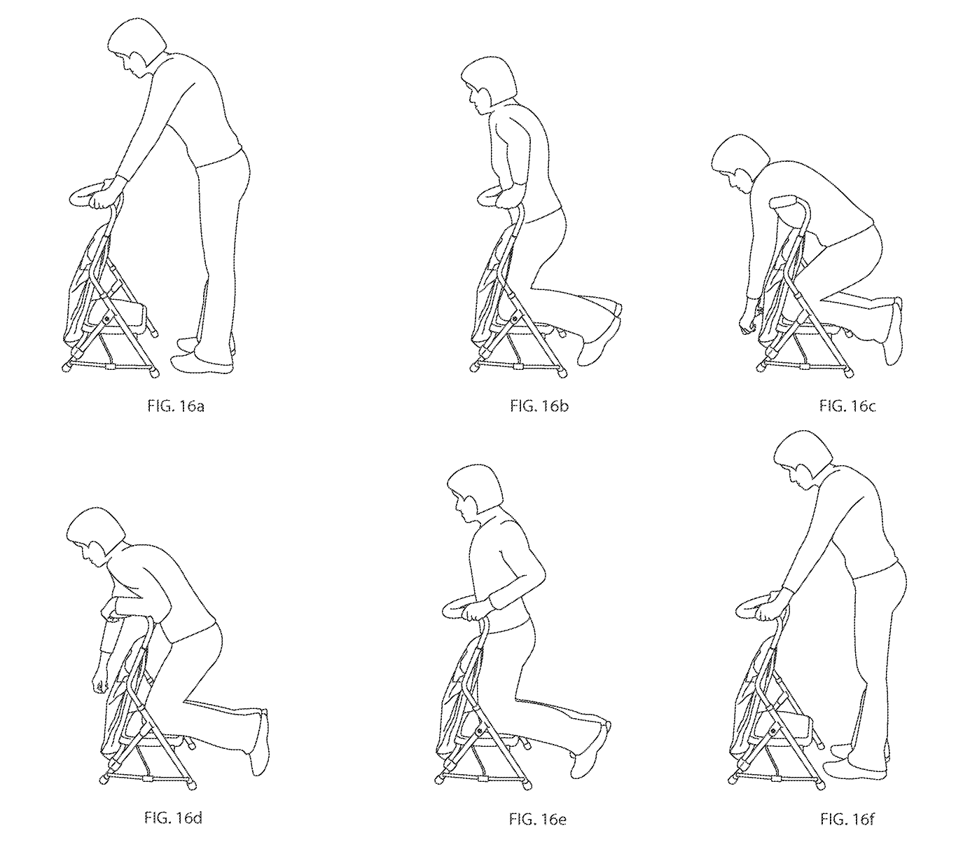

In some examples, first frame portion 56 includes on either side of the knee support member 54, a brace support 65. The brace support 65 braces forward and rearward sections of the first frame member 56. In some implementations, the brace supports 65 can fold inward and the knee support member 54 can flip up so that the first frame member 56 assumes a collapsed configuration. FIG. 15a shows the device 50 where the first frame member 56 is in a collapsed configuration, as opposed to the deployed configuration of the first frame member 56 in FIGS. 11-13. FIG. 14 shows an example work-assist device 68 that is similar to device 50, but which includes an alternative version 70 of the first frame member. First frame member 70 includes a rounded or curved bar on each side of the knee support member 54 and attached to the knee support member 54. First frame member 70 also includes the brace supports 65. With any of the devices shown in FIGS. 11-13 or FIGS. 15a-b, 16a-f, or 17-22, the alternative first frame member 70 can be used rather than the first frame member 56. Also, alternative first frame member 70 can include any of the features discussed herein with reference to first frame member 56, including collapsibility and knee support member height adjust functionality, for example.

Referring again to FIG. 11, the second frame portion 58 extends from the first frame portion 56 to the chest support member 52, and includes a forward- angled portion 62 that extends generally forward from the first frame portion 56, and a rearward-angled portion 64 that extends generally rearward from the forward-angled portion 62. The forward-angled portion 62 and the rearward-angled portion 64 intersect at a junction 66. The configuration and angles of the second frame portion 58, and the relative position of the knee support member 54 and the chest support member 52 provide for a balanced and supportive device 50 during use. In some examples, the second frame portion 58 includes a pivoting mechanism 72 (e.g., a hinge) on each side of the device that permits the chest support member 52 to collapse downward and forward for convenient storage or transport. FIG. 15b is a view of the device 50 in a collapsed configuration, where the first frame portion 56 is collapsed and the second frame portion 58 is collapsed.

First frame portion 56 and second frame portion 58 can be aluminum tubing in some examples, and can have any appropriate cross-sectional shape. In the depicted examples, first frame portion 56 (or 70, FIG. 14) and second frame portion 58 have a circular cross-sections, but in other examples one or both of the frame portions may have a rectangular, square, elliptical, triangular, or other appropriate cross-sectional shape. In other examples, one or both of the frame portions 56, 58 can be formed of plastic, or of another type of metal (e.g., steel, stainless steel). In some examples, the tubing of the frame portions can be 0.5″ tubing. In some examples, the tubing of the frame portions can be 0.75″ tubing. In some examples, the tubing of the frame portions can be 1.0″ tubing.

In some examples, second frame portion 58 includes an upper telescoping portion and a lower telescoping portion, each of which can include one or more (e.g., one, two, three, four, five, six, seven, eight, or more) holes 74 (see FIG. 14). In some examples one of the telescoping portions includes a single hole and the other telescoping portion includes several holes. Appropriate holes of the respective telescoping portions may be aligned, and a pin may be inserted through the holes to set the height or length of the second frame portion. In some examples, the upper telescoping portion slides within the lower telescoping portion, and in other examples the lower telescoping portion slides within the upper telescoping portion.

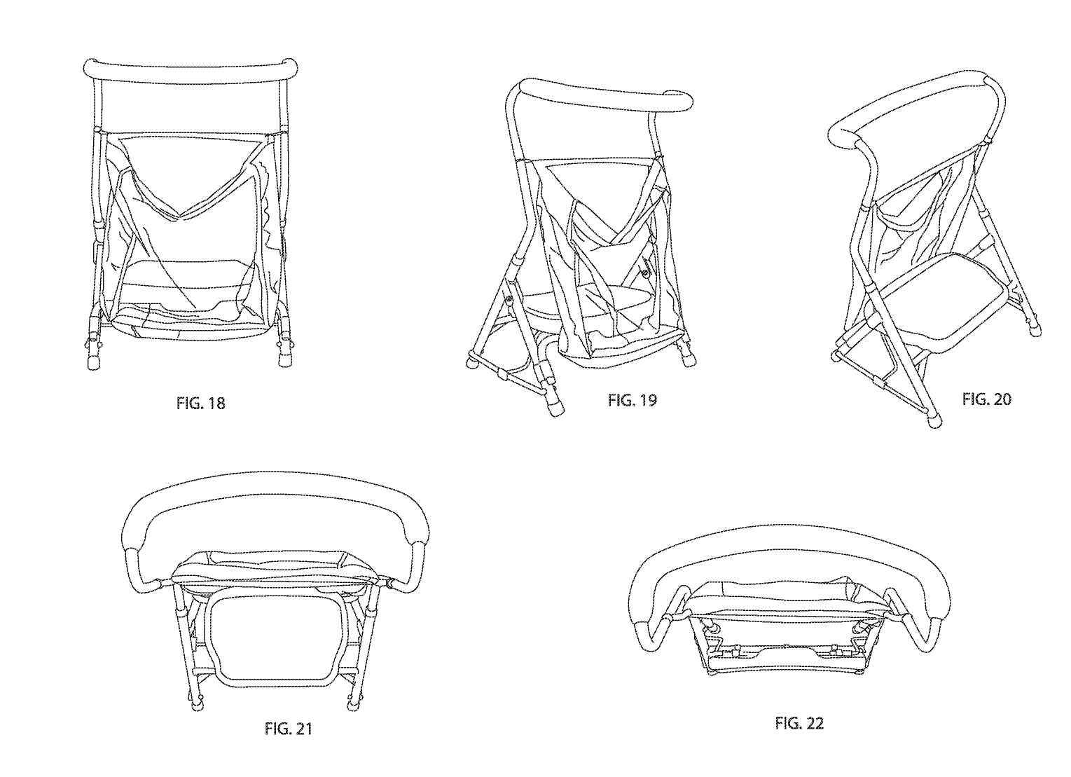

In some examples, the chest support member 52 includes a curved, padded bar that is configured to comfortably support a user's chest when the user is using the device 50. As can be seen in FIGS. 21 and 22, the bar has a generally semi-elliptical curve. In some examples, the bar has a generally semi-circular curve. The chest support member 52 is attached at each end or the bar to the second frame portion 58. As can be seen in FIG. 11, the curved and padded bar of the chest support member 52 is angled downward at an angle of roughly 20 degrees, in this example. In some examples, the bar is angled down at an angle in the range of about 5-45 degrees (e.g., about 5 degrees, about 10 degrees, about 15 degrees, about 20 degrees, about 25 degrees, about 30 degrees, about 35 degrees, about 40 degrees, about 45 degrees). In some examples, the angle may be adjustable, as by a pivoting feature with a locking mechanism, for example. In some examples, an additional bar (not shown) can be included below the chest support bar 52 and across the device so that a user may hang tools, for example, on the additional bar.

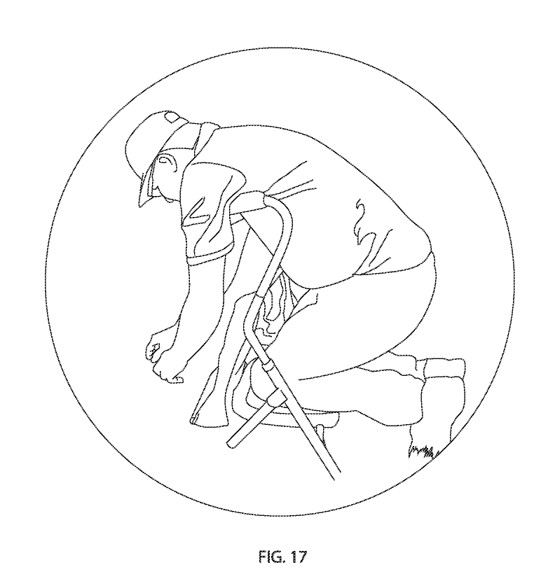

FIGS. 16a-16f are views of a user using the example work-assist device 50 of FIG. 11. FIG. 16a shows a user preparing to lower herself onto the device 50. The user is shown grabbing each side of the chest support member 52 in FIG. 16a. FIG. 16b shows the user lowering herself onto the device 50. The user has lowered her knees onto the knee support member 54 in FIG. 16b, and has done so supporting herself using the chest support member 52 as she lowers herself. FIG. 16c shows that the user has lowered her chest onto the chest support member 52, that the user's knees remain on the knee support member 54, and that the user is now in a comfortable working position, with both hands free to work near the ground. The user's arms are draped over the chest support member 52. The user's weight is being fully supported by the device 50, without straining the user's knees, lower back, or ankles. In particular, the device 50 positions the user's back in a relatively straight and un-arched position, so that the user is unlikely to experience discomfort due to back strain, even during extended working sessions using the device. Also, the device 50 positions the user's knees and lower legs in a comfortable orientation relative to the ground, permitting the user's feet and ankles to comfortably dangle to the ground without undue stress on the user's ankles, feet, or toes.

FIG. 16d shows the user preparing to raise herself from the device 10. The user has raised her chest slightly and placed one hand on the chest support member 52, and is preparing to push her chest further away from the chest support member 52. As compared to the view of FIG. 16d, the user in FIG. 16e has leaned back and positioned her hands on the sides of the chest support member 52. FIG. 16f shows the user raising herself from the device 50. In raising herself, the user pushes downward on the chest support member 52, transfers her weight from her knees to her feet, and straightens her legs, all the while using the sides of the chest support member 52 for support.

FIG. 17 is a view of a user working using the example work-assist device 50. As can be seen in FIG. 17, the user's knees are comfortably resting on the knee support member 54, and the user's chest is comfortably resting against the chest support member 52. The user's arms are comfortably draped over the front of the chest support member 52, and the device 50 facilitates a comfortable working position. The user's legs extend behind the device generally parallel to the ground and about 3-4 inches above the ground, so that the user's feet comfortably dangle to the ground and the user's ankles, feet, and toes are not stressed. The device provides stable and comfortable support in a forward-biased position, so that both of the user's hands are free to perform work (e.g., gardening) and so that the user does not need to use one or both of his hands to support himself while working. The device may be configured to position the user to work in a position where the user would otherwise fall forward because of the forward bias if not for the support provided by the device. In the depicted example, the user is gardening, but as described above, the device can be used for many types of work.

FIG. 18 is a front view of the example work-assist device 50. FIGS. 19 and 20 are perspective views of the work-assist device 50. FIG. 21 is a top view of the work-assist device 50 in a deployed configuration. FIG. 22 is a top view of the example work-assist device 50 in a partially collapsed configuration.

In some examples, any of the devices in FIGS. 11-22 can include one or more (e.g., four) wheels that can be attached to the bottom of the first frame member 56 or 70 to facilitate mobility of the device 50 or 68. For devices 50 or 68 that include wheels, the user could push with her toes against the ground to cause the device to move, without having to get up from the device and while remaining in a working position on the device. FIG. 48 is a front view of an example work-assist device 400 that is similar to the work assist devices 50 and 68 described above with reference to FIGS. 11-22. Device 400 includes wheels 402 at each of the four corners of the device 400. In some examples, the wheels 402 are configured to permit the device 400 to roll in any desired direction. In some examples, the wheels are configured to permit the device 400 to roll in a lateral, side-to-side direction, which may be useful in a shelf-stocking retail application, for example.

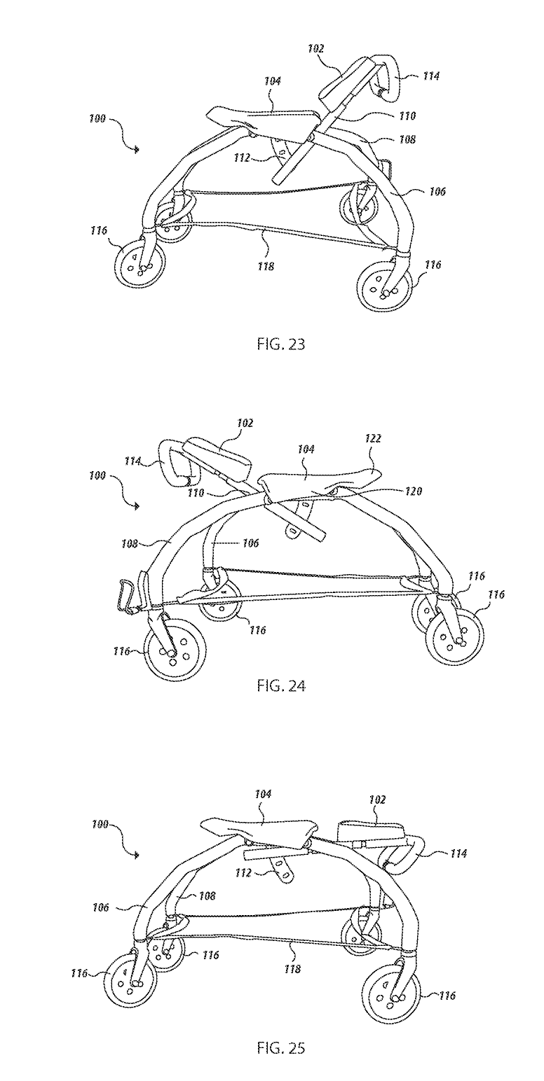

FIGS. 23, 24 and 25 are views of another embodiment of an example work-assist device 100. Without limitation, the work-assist device 100 can be used for gardening, ceramic tiling, floor treatment or restoration, painting, auto detailing, maintenance or repair, retail stocking, general household cleaning, or other uses. In some examples, the device 100 can be used to provide mobility for persons with a disability or movement limitations. The work-assist device 100 includes a chest support member 102, a saddle 104, a first frame tube 106, a second frame tube 108, a third frame tube 110, an angle adjustment component 112, a handle component 114, wheels 116 (four, in the depicted example), and an optional storage member 118. The chest support member 102 and the handle component 114 are attached to the third frame tube 110. The third frame tube 110 is attached to the first and second frame tubes 106 and 108, and to the angle adjustment component 112. The saddle 104 and the angle adjustment component 112 are attached to the first and second frame tubes 106 and 108. The first and second frame tubes 106 and 108 are curved tubes, and each of the wheels 116 are attached to a respective end of the first frame tube 106 or the second frame tube 108. The optional storage member 118 is attached, in this example, to the first and second frame tubes 106 and 108.

As can be seen in FIGS. 23-25, an orientation of the chest support member 102 and handle component 114 with respect to the saddle 104 and the first and second frametubes 106 and 108 is adjustable. For example, the angle adjustment component 112 includes a series of holes (three, in the depicted example) along the length of the angle adjustment component 112, and the third frametube 110 includes one or more holes near a lower end of the tube 110. A hole of the third frametube may be aligned with one of the holes of the angle adjustment component 112, and a pin can be inserted through the aligned holes to set an orientation of the third frametube 110, the chest support member 102, and the handle component 114.

FIG. 23 is a side perspective view of the device 100 that shows the third frametube 110 (and the chest support member 102 and handle component 114) in a first, generally upright position. In the example of FIG. 23, the chest support member 102 defines an angle of about 120 degrees with saddle 104. FIG. 25 is a side perspective view of the device 100 that shows the third frame tube 110 (and the chest support member 102 and handle component 114) in a second, generally flat position. In the example of FIG. 23, the chest support member 102 defines an angle of about 180 degrees with saddle 104. FIG. 24 is a side perspective view of the device 100 that shows the third frame tube 110 (and the chest support member 102 and handle component 114) in a third position, generally between the upright position of FIG. 23 and the flat position of FIG. 25. In the example of FIG. 24, the chest support member 102 defines an angle of about 150 degrees with saddle 104. In some examples, an angle of the third frametube 110 is continuously adjustable between a first angle (e.g. about 120 degrees) and a second angle (e.g., about 180 degrees) with respect to the saddle 104.

The saddle 104 is configured to support a user's buttocks, and can include a platform that is attached to the first and second frame tubes 106 and 108, and a pad member that is attached to the platform. The saddle 104, or the pad of the saddle, can have various shapes. In some examples, the saddle 104 is generally flat or planar. In some examples, the saddle 104 can include side portions 120 that respectively extend downward from the lateral sides of the saddle. A rear portion of the saddle 104 may include an upward sloping lip 122 in some examples. A width of the saddle 104 may taper, in some examples, from the front to back of the saddle (see e.g., FIG. 35).

The chest support member 102 is configured to support a user's chest when the user is using the work-assist device 100. The chest support member 102 can include a platform that is attached to the third frame tube 110, and a pad member that is attached to the platform. The chest support member 102, or the pad of the chest support member, can have various shapes. In some examples, the chest support member 102 is generally flat or planar. In some examples, the chest support member 102 has a contour.

First, second and third frame tubes 106, 108, and 110 can be aluminum tubing in some examples, and can have any appropriate cross-sectional shape. In the depicted examples, first, second and third frame tubes 106, 108 and 110 have circular cross-sections, but in other examples one or more of the frame portions may have a rectangular, square, elliptical, triangular, or other appropriate cross-sectional shape. In other examples, one or more of the frame tubes can be formed of plastic, or of another type of metal (e.g., steel, stainless steel). In some examples, the tubing of the frame tubes can be 1.5″ tubing or 1.75″ tubing. In some examples, the tubing of the frame portions can be 0.75″ tubing or 1.00″ tubing.

In some examples, a length of the third frame tube 110 is adjustable, so that a distance between the saddle 104 and the chest support member 102 may be adjusted to accommodate users of different sizes. For example, the third frame tube 110 can include an upper telescoping portion and a lower telescoping portion, each of which can include one or more (e.g., one, two, three, four, five, six, seven, eight, or more) holes. In some examples one of the telescoping portions includes a single hole and the other telescoping portion includes two or more holes. Appropriate holes of the respective telescoping portions may be aligned, and a pin may be inserted through the holes to set the height or length of the third frametube 110. In some examples, the upper telescoping portion slides within the lower telescoping portion, and in other examples the lower telescoping portion slides within the upper telescoping portion.

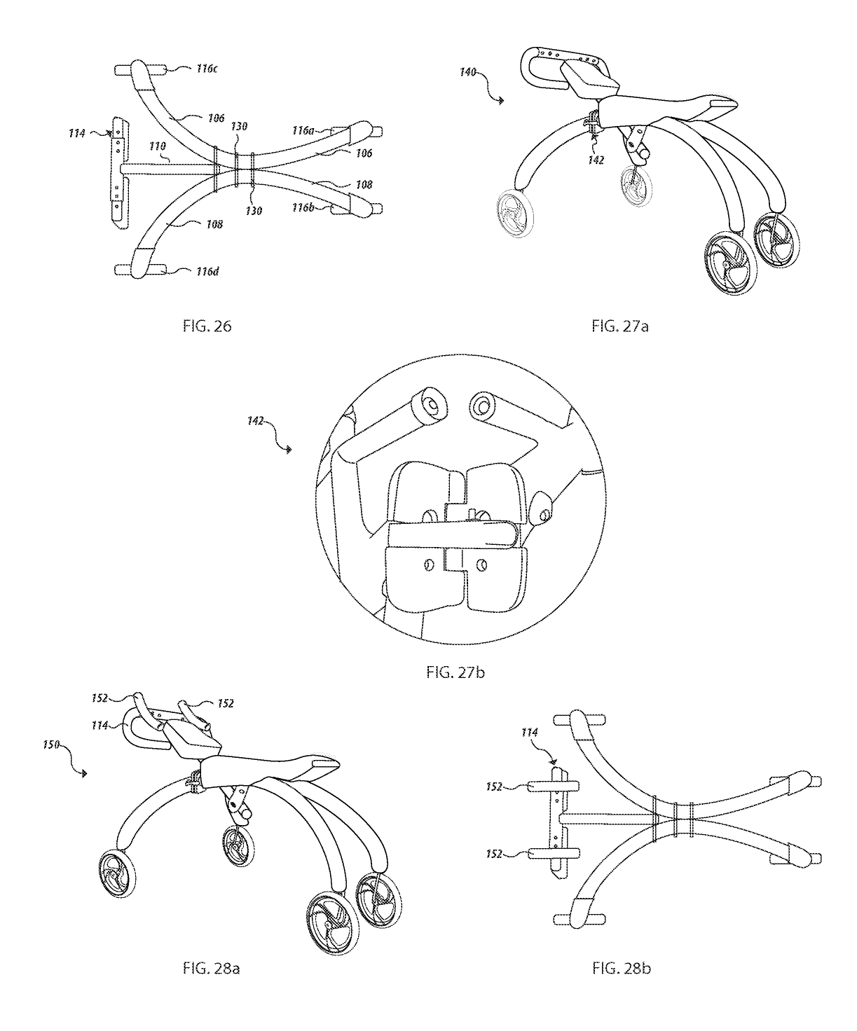

In some examples, a width of the handle component 114 is adjustable. For example, the handle component 114 may include telescoping portions with holes (see e.g., FIG. 26), so that handle component width may be adjusted in a similar manner as the third frame tube length may be adjusted in some implementations. In some examples, an angle of the handle component 114 may be adjustable. As can be seen with reference to FIG. 25, the handle component 114 defines an angle of about 60 degrees with the chest support member 102, but in other examples the handle component 114 can define an angle of about 80 degrees, 75 degrees, 70 degrees, 65 degrees, 55 degrees, 50 degrees, 45 degrees, 40 degrees, 35 degrees, or 30 degrees with the chest support member 102. In some examples, the width of the handle component 114 is fixed. In some examples, the angle between the handle component 114 and the chest support member 102 is fixed.

The wheels 116 may be oversized for easy rolling over soft or rough terrain, such as grass, dirt, gravel, concrete, or interior floor surfaces. The wheels can include plastic and rubber portions, as is known to those of skill in the art, and may be attached to the frame tubes 106, 108 in any appropriate manner, as will also be known to one of skill in the art.

FIG. 26 is a top view of example frame components of the work assist device 100 of FIG. 23. As can be seen in FIG. 26, first and second frame tubes 106 and 108 are curved, and are connected to one another near a midpoint or center of the tubes 106, 108. The tubes are shown connected by one or more (e.g., one, two, three, or more) bolts 130 that extend through the frame tubes 106 and 108. Based on the curved configuration of the first and second frame tubes 106 and 108, rear wheels 116a and 116b are separated by about 10-12 inches in some examples, and front wheels 116c and 116d are separated by about 30-36 inches in some examples. For example, the wheelbase at the front of the device 100 may be about 30-36 inches, and the wheelbase at the rear of the device may be about 10-12 inches. In some examples, the front wheelbase of the device 100 may be about three times as wide as the rear wheelbase. The narrower rear wheelbase may facilitate easier mounting of the device, as by simply approaching the device from behind and walking forward until standing over the device, without having to swing a leg over the side of the device, for example. The wider front wheelbase may provide forward-based support to prevent the device from flipping forward when the user is using the device and working in a forward-biased position, for example.

FIG. 27a is a perspective view of another example work assist device 140. Device 140 is similar to device 100, but includes a collapsing mechanism 142 that permits the device 140 to partially collapse for ease of storage or transport. In some implementations, collapsing mechanism 142 may be a vice clamp locking mechanism, and may permit the forward portions of first and second frame tubes 106 and 108 to fold rearward toward the rear portions of first and second frame tubes 106 and 108. FIG. 27b is an enlarged view of the collapsing mechanism 142 of the device 140 of FIG. 27a.

FIG. 28a is a perspective view of yet another example work-assist device 150. Device 150 is similar to device 100 and device 140, and includes one or more (two, in this example) shoulder support members 152 that are attached to the handle component 114. The shoulder support members 152 are configured to receive and support the user's shoulders when the user is using the work-assist device 150. As can be seen in FIG. 28a, the shoulder support members 152 are curved (e.g., a curved and padded bar) for comfortable engagement with the user's shoulders. In some examples, the shoulder support members 152 may rotate or pivot about the handle component 114. FIG. 28b is a top view of example frame components of the work assist device 150 of FIG. 28a.

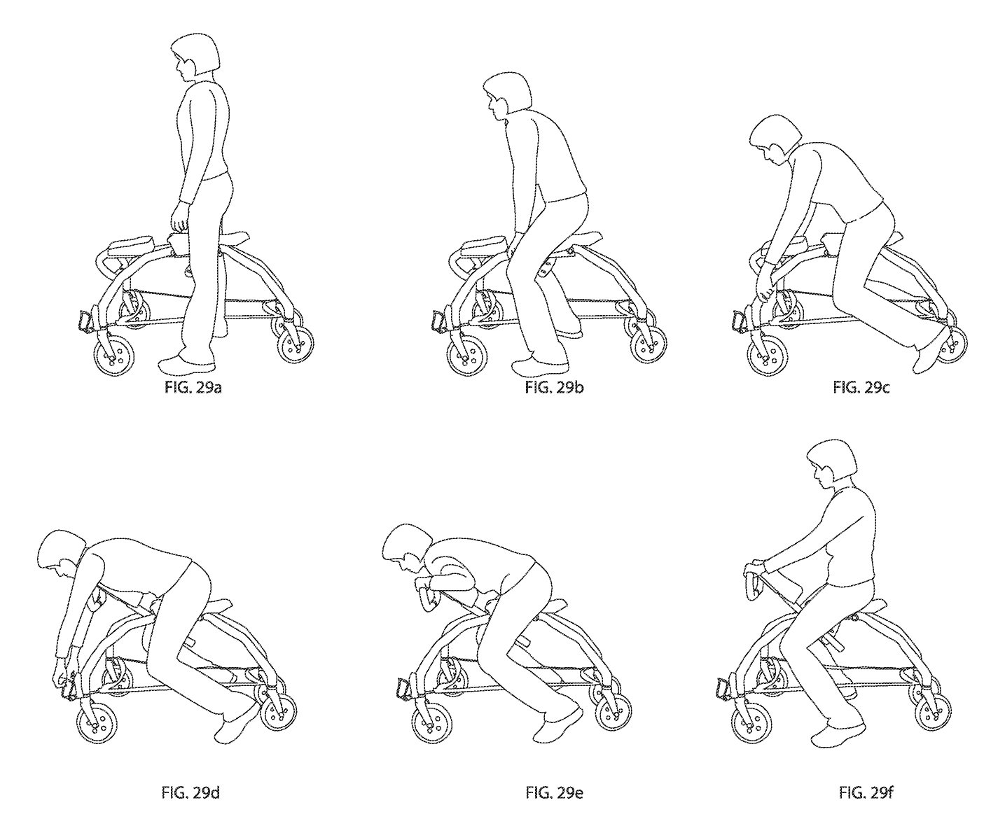

FIGS. 29a-29f are views of a user using the example work-assist device 100 of FIG. 23. FIG. 29a shows a user preparing to lower herself onto the device 100. The user is standing over the device 100, with one leg on either side of the device, having approached the device 100 from the rear, for example, without having to swing a leg over the device. FIG. 16b shows the user lowering herself onto the saddle 104 of the device 100. The user is grabbing a forward portion of the saddle 104 for support as she bends her knees to lower herself down to the saddle 104. In FIG. 16c, the user is preparing to lower her chest down to the chest support member 102. The user is shown holding on to the handle component 114 for support of her upper body as she lowers her chest down to the chest support member, which is in a generally flat configuration in the depicted FIG. 29c example.

With reference now to FIG. 29d, the user may have determined that she would prefer that the chest support member 102 be angled at an intermediate position rather than at a low or flat position (as in FIG. 29c). The user may have conveniently adjusted the angle of third frame tube 110 (e.g., using the angle adjustment component 112), so that in FIG. 29d the chest support member 102 is in an intermediate position. FIG. 29d shows that the user has lowered her chest onto the chest support member 102, that the user's buttocks remain on the saddle 104, and that the user is now in a comfortable working position, with both hands free to work near the ground. The user's arms are draped over the handle component 114. The user's weight is being fully supported by the device 100, without straining the user's knees, lower back, or ankles. In particular, the device 100 positions the user's back in a relatively straight and un-arched position, so that the user is unlikely to experience discomfort due to back strain, even during extended working sessions using the device. Also, the device 100 positions the user's knees and lower legs in a comfortable orientation relative to the ground, permitting the user's legs to comfortably dangle to the ground without undue stress on the user's knees, ankles, feet, or toes.

FIG. 29e shows the user preparing to raise herself from the device 100. The user has positioned her hands on the handle component 114, and is preparing to sit up and push her chest away from the chest support member 102. In FIG. 29f, the user is seated upright on the saddle 104 after having raised her chest from the chest support member 102. The user may then stand up and back away from the device 100.

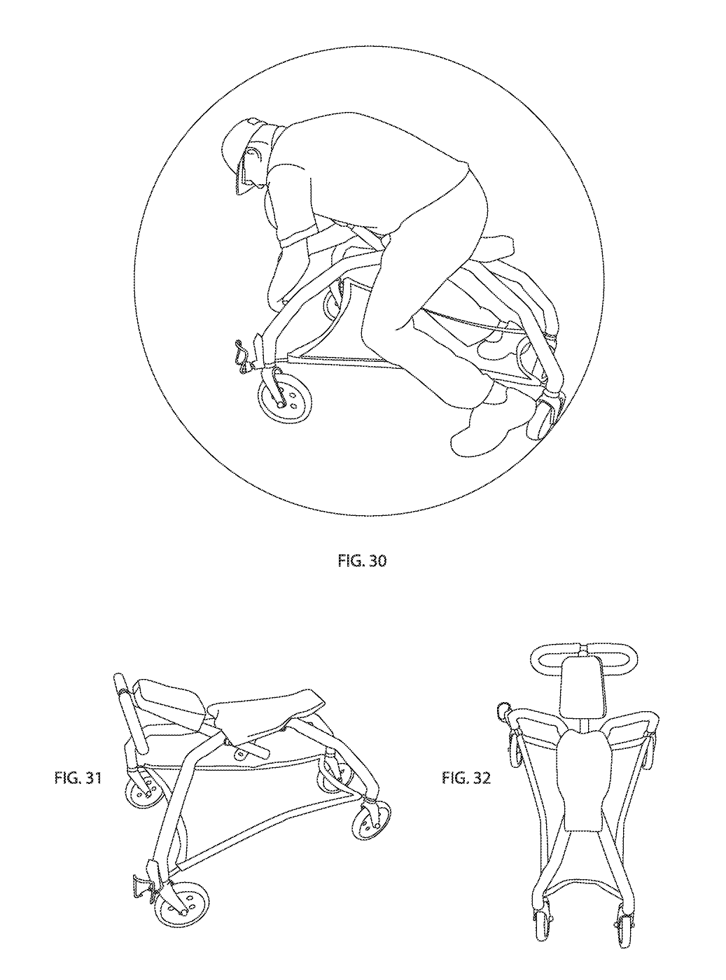

FIG. 30 is a view of a user working using the example work-assist device 100. As can be seen in FIG. 30, the user is comfortably sitting on the saddle 104, and the user's chest is comfortably resting against the chest support member 102. The user's arms are comfortably draped over the front of the chest support member 102 and handle component 114, and the device 100 facilitates a comfortable working position. The device provides stable and comfortable support in a forward-biased position, so that both of the user's hands are free to perform work (gardening in the depicted example) and so that the user does not need to use one or both of his hands to support himself while working. The device may be configured to position the user to work in a position where the user would otherwise fall forward because of the forward bias if not for the support provided by the device. In the depicted example, the user is gardening, but as described above, the device can be used for many types of work.

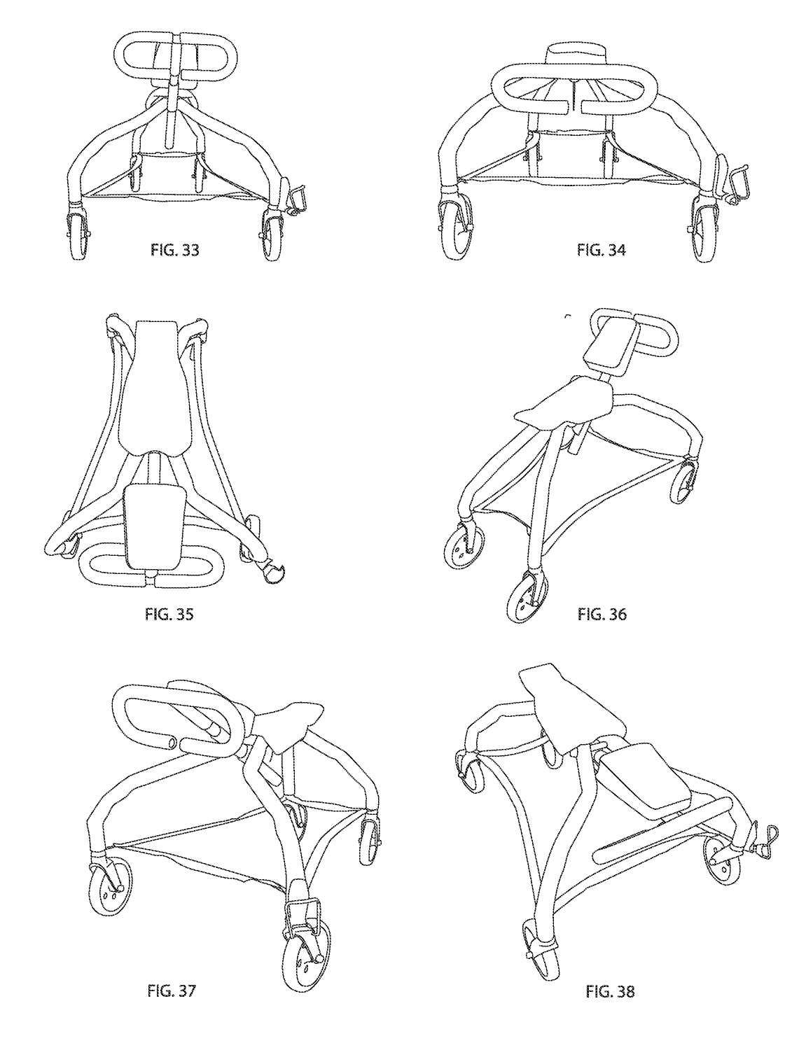

FIG. 31 is a perspective view of the example work-assist device 100. FIG. 32 is a top view of the work-assist device 100. FIGS. 33 and 34 are front views of the work-assist device 100, where FIG. 33 shows the third frame tube 110 in an upright position and FIG. 34 shows the third frame tube 110 in a flat position. FIG. 35 is a top view of the example work-assist device 100. FIGS. 36-38 are perspective views of the example work-assist device 100.

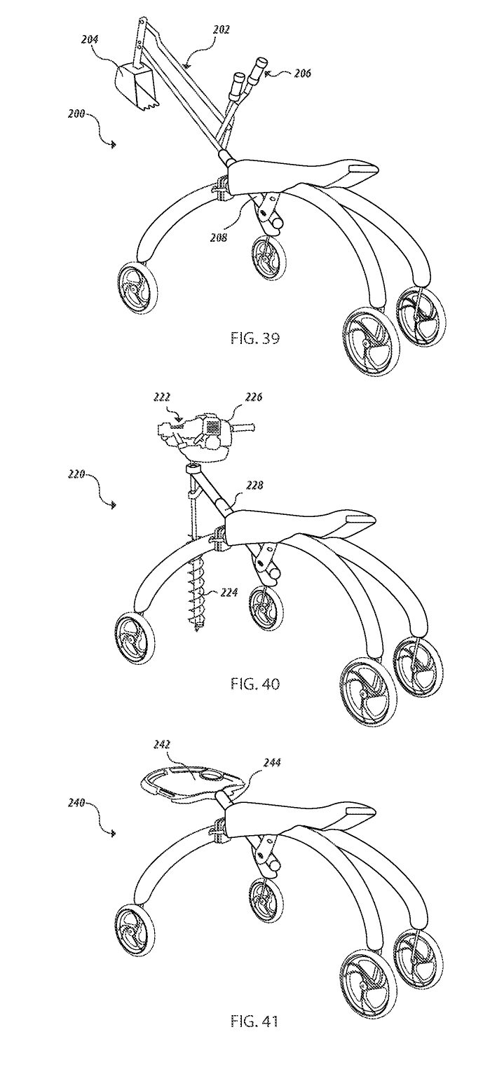

FIG. 39 is a perspective view of an example work-assist device 200 that includes a digger attachment 202. In general, device 200 includes many of the same components as described above with respect to one or more of the devices shown in FIGS. 23-38. Digger attachment 202 includes a bucket 204 that can be used to move material (e.g., dirt, snow, leaves, sand, gravel, rocks, or the like), and can be controlled by one or more hand-operated levers 206 (two shown in this example). For example, a user sitting on the saddle of the device 200 may operate the levers 206 to control the bucket 204 of the digger attachment to perform work using the device 200. In some examples, device 200 includes one or more weights (not shown) near the rear of the device 200 to counter-balance loads moved by the bucket 204. In some examples, digger attachment 202 attaches to a third frametube 208 of the device 200. Third frame tube 208 may be similar to the third frame tube 110 described above, or may be, for example, a lower portion of the third frame tube 110 for examples where tube 110 includes telescoping portions, as described above. Some versions of digger attachment 202 may include additional bars, bars disposed at one or more alternative angles, or both.

FIG. 40 is a perspective view of an example work-assist device 220 that includes an auger attachment 222. In general, device 220 includes many of the same components as described above with respect to one or more of the devices shown in FIGS. 23-38. Auger attachment 222 includes an auger 224 and a motor 226 that causes the auger 224 to rotate so that the auger 224 can be used to move material (e.g., dirt, snow, ice, sand, gravel, or the like). For example, a user sitting on the saddle of the device 220 may operate the motor 226 and raise or lower the auger 224 (e.g., using the depicted control bar) to perform work using the device 220. In some examples, device 220 includes one or more weights (not shown) near the rear of the device 200 to counter-balance the weight of the motor 226 and of loads moved by the auger 224. In some examples, auger attachment 222 attaches to a third frame tube 228 of the device 220. Third frame tube 228 may be similar to the third frame tube 110 described above, or may be, for example, a lower portion of the third frame tube 110 for examples where tube 110 includes telescoping portions, as described above.

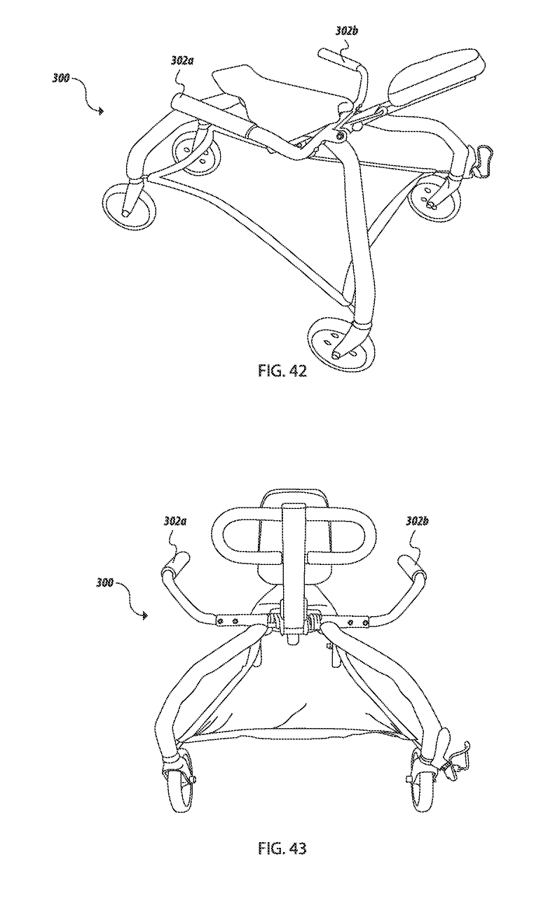

FIG. 41 is a perspective view of an example work-assist device 240 that includes a tray attachment 242. In some examples, the tray attachment 242 is an art tray. In general, device 240 includes many of the same components as described above with respect to one or more of the devices shown in FIGS. 23-38. In examples where tray attachment 242 is an art tray, the tray attachment can be used, without limitation, to hold paint, auto body or detailing materials, tools, cleaning supplies, and the like. In some examples, tray attachment 242 attaches to a third frame tube 244 of the device 240. Third frame tube 244 may be similar to the third frame tube 110 described above, or may be, for example, a lower portion of the third frame tube 110 for examples where tube 110 includes telescoping portions, as described above.

FIG. 42 is a perspective view and FIG. 43 is a front view, respectively, of an example work assist device 300 that includes one or more support handles (two shown in this example). In some examples, a first support handle 302a is attached to the first frame tube 106 and a second support handle 302b is attached to the second frame tube 108. In some examples, one or both of the support handles 302a, 302b is attached to the third frame tube 110. In some examples, the first support handle 302a is attached to the first frame tube 106 and to the third frame tube 110, and the second support handle 302b is attached to the second frame tube 108 and to the third frame tube 110. In some examples, one or both of the support handles 302a, 302b is attached to each of the first frametube 106, the second frame tube 108, and the third frame tube 110.

A user may use one or both of the support handles 302a, 302b for support when lowering oneself onto the saddle of the device from a standing position, for example, or may use one or more of the support handles 302a, 302b when raising oneself from the saddle of the device, to go from a sitting position to a standing position. As can be seen with reference to FIG. 43, each of the support handles 302a, 302b is positioned on a lateral side of the device, and at a height that is a distance (e.g., 2″, 3″, 4″, 5″, 6″, 7″, 8″, or more) higher than the height of the saddle of the device. In various implementations, the support handles 302a, 302b may be fixedly attached to one or more components of the frame of the device as described above, or may be pivotably attached so that the support handles 302a, 302b can fold, rotate, or collapse toward the center of the device 300 for convenient storage. In some examples, a single handlebar component includes both of the support handles 302a, 302b, and is attached to one or more of first frame tube 106, second frame tube 108, and/or third frame tube 110. In some examples, device 300 includes the handle component 114 (seem e.g., FIG. 42), In general, device 300 includes many of the same components as described above with respect to one or more of the devices shown in FIGS. 23-38.

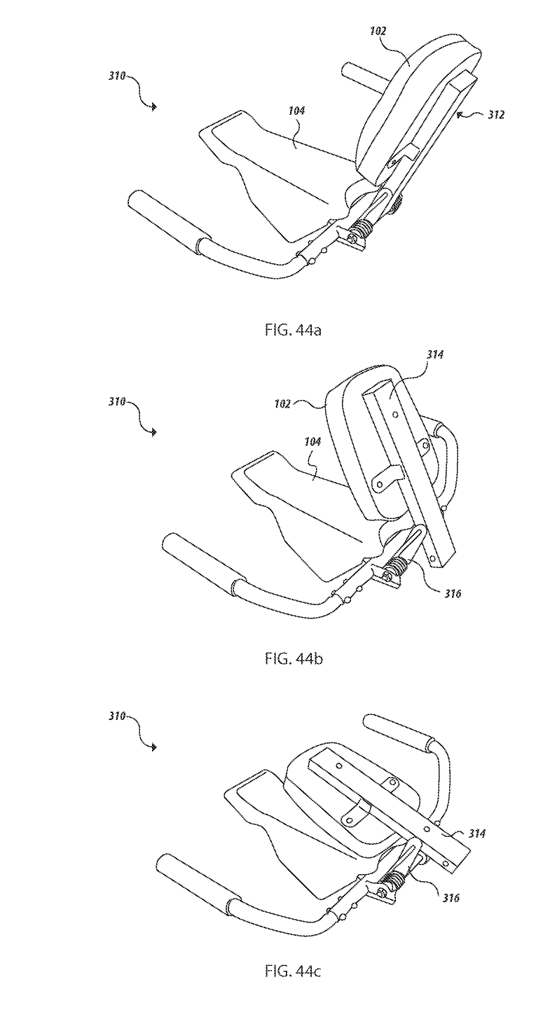

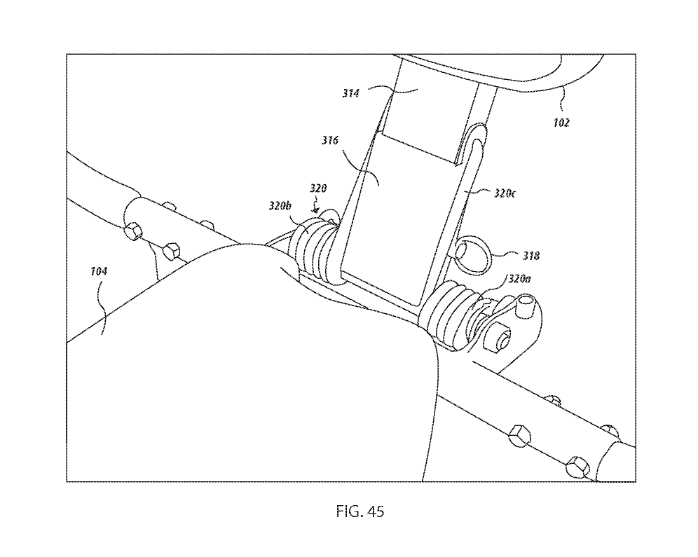

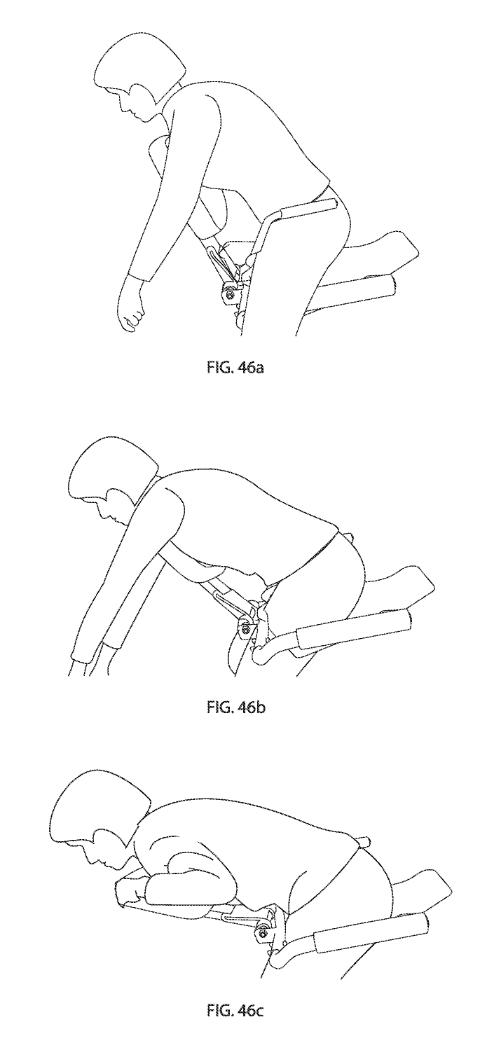

FIGS. 44a, 44b, and 44c are perspective views of a portion 310 of the device 300 of FIGS. 42 and 43. A third frame component 312 includes an upper portion 314, to which the chest support member 102 is attached, and a lower portion 316. Third frame component 312 may correspond to third frame tube 110 in some implementations. The upper portion 314 and lower portion 316 are pivotably coupled to one another, so that the chest support member 102 and the upper portion 314 may fold back toward the saddle 104 for convenient storage. FIG. 44c shows the chest support member 102 and upper portion 314 folded back toward the saddle 104. In some examples, each of the upper portion 314 and the lower portion 316 of the third frame component 312 includes one or more holes that may be aligned, and a pin 318 may be inserted through the appropriate holes to lock the upper portion 314 and the lower portion 316 in a working position. FIG. 44a shows the upper portion 314 and lower portion 316 locked in a working position. The pin 318 is shown more clearly in FIG. 45.

In some examples, the work assist device 300 includes a tension system that provides resistance against forward pressure that is applied to the chest support member 102. For example, as can be seen in FIG. 45, one or more springs 320 or other resistance-providing components ca n be included to provide resistance against forward pressure to the chest support member 102. The resistance against forward pressure to the chest support member 102, provided by the tension system, may conveniently assist a user with assuming a forward-biased working position from an upright seated position, as by providing resistance as the user lowers one's chest against the chest support member 102 and to assume a forward-biased working position. The resistance may similarly aid a user in returning from a forward-biased working position to a more upright seated position. This resistance may permit a user to assume a forward-biased working position in a more controlled fashion, or may permit the user to return to an upright seated position from a forward-biased working position, with a reduced amount of effort on the user's part. In some examples, the tension system may minimize stress or strain on the user's back by supporting a greater portion of the user's forward-biased weight, for example.

In some examples, a first portion of the spring 320 is coiled around the first frame tube 106, a second portion of the spring 320 is coiled around the second frame tube 108, and a third portion of the spring extends through a hole in the third frame tube 110. In the example depicted in FIG. 45, a first portion 320a of the spring 320 and second portion 320b of the spring 320 are coiled around a portion of the frame of the device 300, and a third portion 320c of the spring 320 extends from the first portion 320a to the second portion 320b through the third frame component 312 (for example, through each of upper portion 314 and lower portion 316 of third frame component 312).

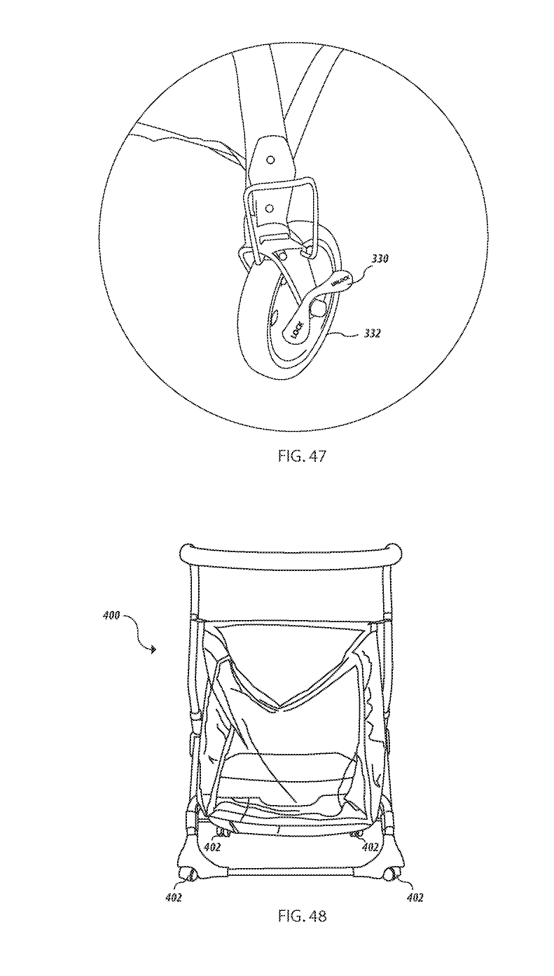

FIGS. 46a, 46b, and 46c are perspective views of a portion of the device 300, and illustrate how the tension system provides resistance to forward pressure against the chest support member 102 of the device 300. In some examples, any of the work assist devices shown in FIGS. 23-43 can include the tension system.

In some examples, any of the work assist devices shown in FIGS. 23-47 can include one or more brake elements 330 that permit one or more wheels 332 of the device to be locked and prevent or restrict rotation of the one or more wheels. FIG. 47 shows an example brake element 330, which may be located in some examples at a front wheel of the device. In some examples, each of the front wheels of the device includes a brake element 330. In use, a user may engage the brake element 330 before mounting the device to prevent the device from moving as the user mounts the device. After mounting the device, the user may disengage the brake element 330, for example, so that the wheel may freely rotate and the user may move about on the device. In some examples, each of the four wheels of the device includes a brake element 330.

In general, any of the work-assist devices depicted or described herein may include one or more of the features of any of the other work-assist devices depicted or described herein.

The above description is intended to be illustrative, without limitation. A number of implementations and examples have been described. Nevertheless, it will be understood that various modifications may be made. Accordingly, other implementations are within the scope of the following claims.

What is claimed is:

1. A work-assist device, comprising:
a chest-support member configured to support a user's chest when the user is using the work-assist device;
a knee-support member configured to support the user's knees when the user is using the work-assist device, the knee-support member comprising a pad having a curved lower surface and configured to cause the work-assist device to rock forward or backward in response to a weight shift by the user when the user is using the work-assist device; and
an elongate frame member that includes a first end and a second end, the first end attached to the knee support member and the second end attached to the chest support member,
wherein the work-assist device is configured to fully support the user in a forward-biased position when the user is using the work-assist device.

2. The work-assist device of claim 1, wherein the knee-support member comprises a second frame member, and wherein the second frame member is attached to the first end of the elongate frame member, and wherein further the pad comprises a left pad and a right pad, each of the left pad and the right pad having a curved lower surface.

3. The work-assist device of claim 1, wherein the elongate frame member extends from the chest-support member at an angle within the range of 45-80 degrees.

4. The work-assist device of claim 3, wherein the angle is about 60 degrees.

5. The work-assist device of claim 1, wherein the elongate frame member comprises a first telescoping portion and a second telescoping portion, and wherein a length of the elongate frame member is adjustable.

6. The work-assist device of claim 1, further comprising a stability member attached to the elongate frame member, wherein the stability member is configured to prevent the work-assist device from rocking forward beyond a predetermined position when the stability member is disposed in an open position.

7. A work-assist device, comprising:
a chest-support member configured to support a user's chest when the user is using the work-assist device;
a knee-support platform configured to support the user's knees when the user is using the work-assist device; and
a frame comprising a first frame portion and a second frame portion, wherein the first frame portion is attached to the knee-support platform, and wherein the second frame portion is attached to the first frame portion and to the chest-support member, each of the first frame portion and the second frame portion being collapsible;
wherein the work-assist device is configured to fully support the user in a forward-biased position when the user is using the work-assist device.

8. The work-assist device of claim 7, wherein the chest-support member comprises a forward- and downward-sloping curved bar.

9. A work-assist device, comprising:
a frame comprising a first frame tube and a second frame tube, the first frame tube and the second frame tube each having a curved configuration and a first end and a second end, the first frame tube attached to the second frame tube at an attachment point near a center portion of the first frame tube and a center portion of the second frame tube;
first and second wheels, attached respectively to the first end of the first frame tube and the second end of the first frame tube;
third and fourth wheels, attached respectively to the first end of the second frame tube and second end of the second frame tube, wherein the first and third wheels define a first wheelbase and the second and fourth wheels define a second wheelbase, the first wheelbase about three times as wide as the second wheelbase;
a chest-support member configured to support a user's chest when the user is using the work-assist device;
a saddle attached to the frame and configured to support the user when the user is using the work-assist-device;
an adjustment member that is attached to the frame;
a third frame tube attached to the chest-support member and to the adjustment member, wherein an angle of the third frame tube with respect to the saddle is adjustable by selecting a setting of the adjustment member;
wherein the work-assist device is configured to fully support the user in a forward-biased position when the user is using the work-assist device.

10. The work-assist device of claim 9, further comprising a storage member attached to the frame.

11. The work-assist device of claim 9, further comprising a handle component attached to the third frame tube.

12. The work-assist device of claim 11, further comprising a first shoulder-receiving element attached to the handle component and a second shoulder-receiving element attached to the handle component.

13. The work-assist device of claim 9, wherein the third frame tube comprises a first telescoping portion and a second telescoping portion, and wherein a length of the third frame tube is adjustable.

14. The work-assist device of claim 9, further comprising a digger attachment.

15. The work-assist device of claim 9, further comprising an auger attachment.

16. The work-assist device of claim 9, further comprising a tray attachment.

17. The work-assist device of claim 9, further comprising one or more springs that provide resistance when pressure is applied to the chest-support member.

18. The work-assist device of claim 9, wherein a width of the saddle tapers from a front portion of the saddle to a back portion of the saddle.

19. The work-assist device of claim 18, wherein the saddle comprises a generally upward-extending rear portion, a generally downward-extending left side portion and a generally downward-extending right side portion.

20. The work-assist device of claim 9, wherein the angle of the third frame tube with respect to the saddle is adjustable in a range of about 120 degrees to about 180 degrees.
